(19) United States
(12) Patent Application Publication
(10) Pub. No.: US 2010/0043020 A1
(43) Pub. Date: Feb. 18, 2010

(54) SYSTEM AND METHOD FOR FINE GRAIN PAYMENT FOR MEDIA SERVICES

(75) Inventors: Andrea Basso, Marlboro, NJ (US); David C. Gibbon, Lincroft, NJ (US); Zhu Liu, Marlboro, NJ (US); Bernard S. Renger, New Providence, NJ (US); Behzad Shahraray, Holmdel, NJ (US)

Correspondence Address: AT & T LEGAL DEPARTMENT - NDQ, ATTN: PATENT DOCKETING, ONE AT & T WAY, ROOM 2A-207, BEDMINSTER, NJ, 07921, US

(73) Assignee: AT&T Labs, Inc., Austin, TX (US)

(21) Appl. No.: 12/192,777

(22) Filed: Aug. 15, 2008

(51) Int. Cl. H04N 5/445; H04N 7/16

(52) U.S. Cl. 725/1; 725/40

(57) ABSTRACT

Disclosed herein are systems, methods, and computer readable-media for recommending media content, the method comprising generating a playlist representing one or more media segments, receiving comments describing the one or more media segments, transmitting the playlist and received comments to one or more viewers, and charging a fee for displaying the media segment represented by the playlist. In one aspect, the fee charged is paid in full or in part by one or more of a recommending party, a third party, one or more viewer, and an advertiser in exchange for inserting advertising content in one or more of the playlist and the comments. Referral credit can be granted recursively when the viewer recommends the playlist to a second viewer and a second fee is charged. In one aspect, received comments are generated based on one or more of media segment metadata, text or audio comments from a recommending party, and previously generated comments describing the media segment. Statistics representing viewing habits of and personal information about the viewer may be collected for use with an election based on the collected statistics.

### SUMMARY

This application relates to application Ser. No. 12/192,732, filed Aug. 15, 2008 (Attorney Docket No.: 2007-1669) the entirety of which is incorporated by reference.

### BACKGROUND OF THE INVENTION

1. Field of the Invention

The present invention relates to media playback and more specifically to charging for media playback on a more granular basis.

2. Introduction

In the traditional cable television subscription plan consumers pay for services they do not use. For example, a cable television subscriber who has no interest in C-SPAN or sports pays for channels which are never viewed. In a blanket music licensing program such as those offered by Broadcast Music, Incorporated (BMI), Muzak, and American Society of Composers, Authors, and Publishers (ASCAP), a business pays a set periodic fee based on factors such as floor space, admission charged, etc. regardless of how much or how little of the licensor's music is actually used. Satellite radio customers pay a package rate that may include channels they do not listen to, such as Howard 101 or Hot Jamz. Bundled packages of channels and other media content allow for little consumer control. Many people select the bundle that has the content they like and consider the bundle a necessary evil.

One approach in the art is to provide cable channels a la carte. This approach is not widespread. Current cable infrastructure is generally regarded as inadequate to support such an approach without converting to all digital or IP TV solutions. Even if cable television is offered on an a la carte basis, a user may still oversubscribe if a single weekly television program is all the user wants. The user is still stuck paying for an entire week of programming on one channel when the user really wants a 30 minute segment once a week.

Accordingly, what is needed in the art is a way to provide and pay for selected media individually per use rather than in media bundles or packages.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed are systems, methods, and computer readable-media for recommending media content, the method comprising generating a playlist representing one or more media segments, receiving comments describing the one or more media segments, transmitting the playlist and received comments to one or more viewers, and charging a fee for displaying the media segment represented by the playlist. In one aspect, the fee charged is paid in full or in part by one or more of a recommending party, a third party, one or more viewer, and an advertiser in exchange for inserting advertising content in one or more of the playlist and the comments. Referral credit can be granted recursively when the viewer recommends the playlist to a second viewer and a second fee is charged. In one aspect, received comments are generated based on one or more of media segment metadata, text or audio comments from a recommending party, and previously generated comments describing the media segment. Statistics representing viewing habits of and personal information about the viewer may be collected for use with an election based on the collected statistics.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates an example method embodiment;

FIG. 3 illustrates a sample system flow chart;

FIG. 4 illustrates how users interact with an example system; and

FIG. 5 illustrates a referral tree.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

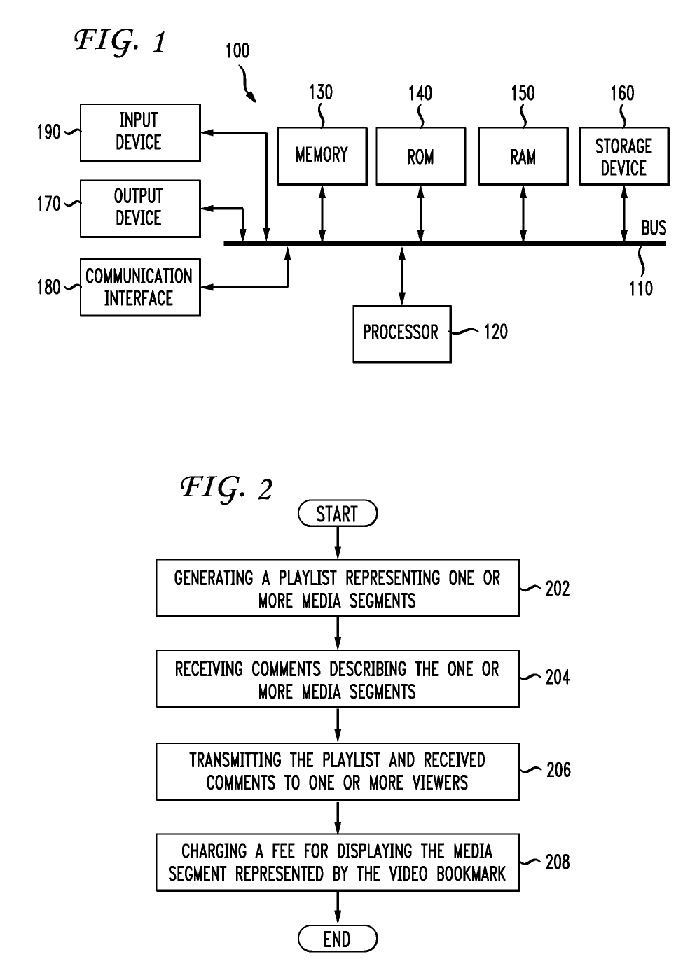

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

The method described herein can be used to “pay by the drink” for media consumption. The phrase “pay by the drink” means that the viewer, one or more third party, or both pay for media on a consumption basis. The method allows a user to purchase media consumption on a more granular basis than the traditional cable television subscription package or even an a la carte cable package. The granularity can cover total time viewed, individual clips viewed, etc. Users are charged for media consumption on a per use basis. The method described herein applies to all types of media, including video, audio, multimedia presentations, educational seminars and training, books, photographs, streamed television, web pages, etc.

FIG. 2 illustrates an example method embodiment. First the method includes generating a playlist representing one or more media segments (202). The generated playlist represents media that a user or users want to consume. The media segments and/or comments may be encapsulated within a container file format, such as video bookmarks as described in related application Ser. No. 12/192,732, filed Aug. 15, 2008 (Attorney Docket No.: 2007-1669). A playlist of media segments can be a list of songs on a Compact Disc (CD), where each song is a media segment. A playlist of media segments can be a Digital Versatile Disc (DVD) movie, where each designated chapter is a media segment. Media segment types can be homogeneous or heterogeneous within a playlist. The playlist can contain references or links to media segments or the playlist may contain the actual media. The playlist and media segments can be stored on removable media, on one or more servers, distributed across a network, stored on local playback devices, or a mixture.

Second, the method includes receiving comments describing the one or more media segments (204). Comments can be generated based on one or more of media segment metadata, text or audio comments from a recommending party and/or previously generated comments describing the media segment. Comments may be automatically generated text or speech incorporating metadata, for example. In a typical scenario, two people, Abel and Baker, are friends. Abel views a video clip online which he wants to share with Baker. The system packages the video clip in a playlist either by itself or with other media segments. In addition to metadata already present in the video clip, Abel provides a comment to his friend Baker like “Baker, you have to see the car crash at the end!” or “Check out this dancing pet rock”. The system includes or associates the speech Abel provides as a comment with the video clip. The speech is converted to text which is also included as a comment. Speech can be converted to text using any method now known or yet to be developed. Comments can be replaced by references to remotely stored comments in the case of online or network-connected playback devices.

Third, the method includes transmitting the playlist and received comments to one or more viewers (206). Continuing the Abel and Baker example above, the system transmits the playlist and comments to Baker. In one aspect, Abel fills out a web form which sends an email to Baker containing the playlist itself or a link to the playlist. Abel could also manually compose an email to Baker with a custom link indicating that Abel is the referring party. In another aspect, Abel views the clip on a video game console and tags it for delivery over the Internet to Baker's video game console. Other ways exist by which Abel can transmit the playlist and comments to other viewers. Transmission can include direct download to a playback device, email attachment, analog or digital broadcast, a link to a network location, a link to a website or IP address, a link to an RSS feed, etc.

Consider further that Abel has two more friends, Clark and Doug. Abel decides to share with Clark and Doug the same playlist he previously shared with Baker. The same playlist and generated comments can be sent to each of them in the ways discussed above or Abel can tailor the comments or the playlist or both for Clark and Doug as a group separate from Baker or Abel can provide comments for each individually.

Fourth, the method includes charging a fee for displaying one or more media segment (208). In the example of Abel recommending to Baker, Clark, and Doug, many variations are possible. Suppose the price to view the video clip is $1.00. In one straightforward scheme, each viewer is charged for what they view. In that case, Abel, Baker, Clark, and Doug each pay $1.00. Abel can authorize payment for Baker, but not for Clark or Doug. In that case, Abel pays $2.00 for himself and Baker, while Clark and Doug each pay $1.00. Abel can authorize partial payment for each, for example $0.50. In that case, Abel pays $1.00 for himself and $1.50 for Baker, Clark, and Doug for a total of $2.50, while Baker, Doug, and Clark each pay $0.50. Abel can specify that he wants to spend $3.00 and no more to view and share the video with others. In that case, Abel pays $1.00 to view the clip and pays for the first two of Baker, Clark, and Doug who view the clip. The last viewer is out of luck and pays for it himself. These examples illustrate a few of the many possible payment schemes. Non-recommending, non-viewing parties can be charged, such as an employer, school, parent, or advertiser. Viewing an advertisement before or after the video can count as a full or partial credit toward a charge. Abel can designate a unique payment scheme for each individual or group of individuals. The fee charged can be paid in full or in part by one or more of a recommending party, a third party, one or more viewer, and an advertiser in exchange for inserting advertising content in one or more of the playlist and the comments.

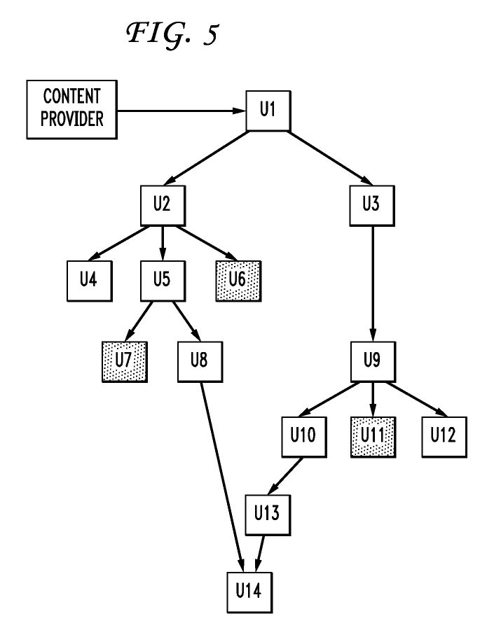

One aspect relates to referral credits. Referral credit is granted recursively when the viewer recommends the playlist to a second viewer and a second fee is charged. An example of this aspect is depicted in depth later in FIG. 5. The basic concept is that Abel recommends the clip to people and when they in turn choose to view the clip and pay for it, a portion of the money paid is given to Abel as a referral fee.

In another aspect, the method further includes a step of collecting statistics representing viewing habits and personal information about the viewer. Statistics can be reported to one or more central servers. Statistics can include aggregated information about user generated comments, revenue generated, the number of unique viewers, the number of times the media has been displayed, demographic information, which clips may be related based on user recommendations and behavior, etc. Viewers can wholly or partially opt in or opt out of a program to collect statistics. Content providers or advertising providers can offer a monetary incentive to viewers who allow for collection of personal statistics because the additional information allows for more targeted and effective advertising. The monetary incentive may be in the form of reduced charges, a rebate check, credits toward future media consumption, coupons, merchandise, etc.

When statistics are gathered, one potentially useful statistic is the number of times a video clip is viewed. A voting system can be formed to hold an election based on collected statistics. The election can be a simple way to indicate popularity of a set of video clips or may be used for a more traditional election such as the elections currently held via telephone and/or text message on American Idol. Elections can be held not only to indicate a single video clip that is popular, but which metadata or comments are popular as well.

The method described is useful in the context of education. A professor prepares audio or video lectures and packages them into a playlist. Lectures can be packaged all at once for an entire course, can be packaged in a weekly format, or can be incrementally packaged, meaning that each new lecture is added to the previous lecture, creating a large playlist of all the lectures up to that point. The professor prepares class notes or an outline for use with the lectures. The notes or outline can be plain text or an enriched media format such as a separate audio track with additional explanations or answers to common questions. Other examples of an enriched media format include a Microsoft® PowerPoint® presentation or an OpenOffice® Impress® presentation. The viewers in this scenario are the students, other teachers, teachers' aides, etc. Students pay a fee in advance for viewing the content either as a part of the tuition or as a separate fee available to enhance the class, much in the same way that supplemental textbooks are suggested as helpful but not required. Students can also pay for each lecture individually if they miss a class or want to review. The fee for teachers or teachers' aides can be paid for or waived by the educational institution. To ensure that non-students do not participate in the class, the course lectures are made available only to a closed group of subscribers or students.

Another application of the described method is a wedding, house party, or other event where a host wants to entertain guests with music. The host can browse a library of online and/or offline media and assemble a custom playlist of songs catered to match the event and the guests. The host can even create multiple playlists geared toward different locations and/or times in the same event. In a wedding example, soft, soothing music is selected for the bride's dressing room, more traditional wedding music is selected for the main hall during the ceremony, and romantic dance music is selected for the main hall during the reception. The host records audio vignettes describing how the song relates to or represents the bride or groom. The host can record audio comments about each song. The system plays the comments and media in the playlist for guests to enjoy. In a wedding it is impractical to charge guests for the music they hear. The host can pay a reduced or discounted bulk rate for playing music for guests, but on a more refined, granular scale than a blanket monthly fee charged by organizations like BMI or ASCAP. Instead of charging by the month, the host may be charged at the end of the reception based on actual or estimated attendance and on the duration of the wedding festivities. The playlist for a wedding is adaptable on the fly. Songs on the playlist can be added and removed at will by the host or guests if the host so authorizes. Guest requests for a particular song can be aggregated as user statistics to allow for an election to determine which songs to add to or remove from the playlist or which song to play next in the playlist.

In one implementation, the system provides an interactive user interface via a web page on the Internet which asks users some questions to create a profile. The system generates a quick playlist based on the user profile which the user can then elaborate upon. The playlist contains actual comments on the media in the playlist but only pointers to the media content.

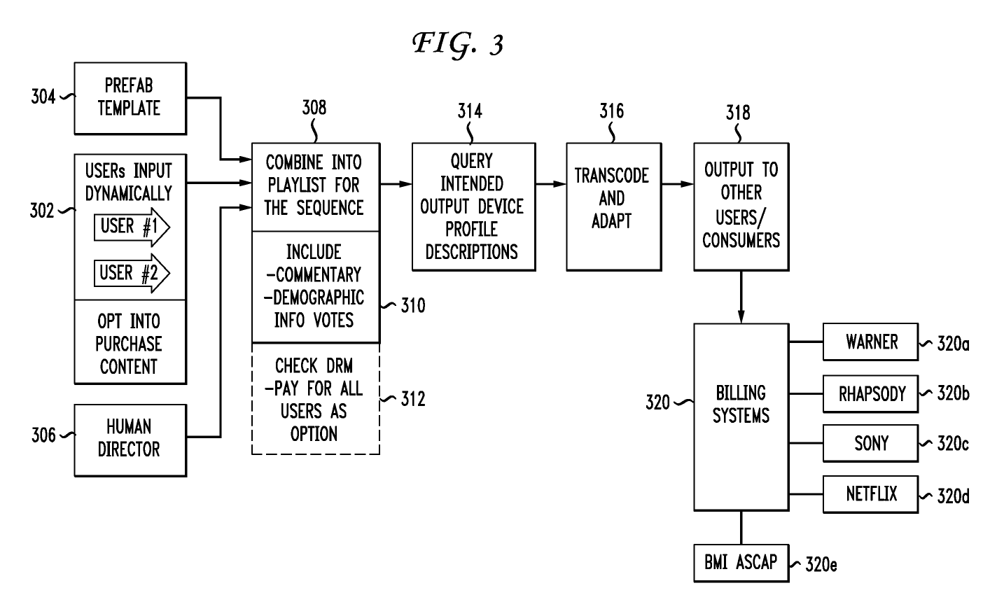

FIG. 3 illustrates a sample system flow chart. The system creates a playlist based on dynamic input from multiple users 302, a prefabricated template 304 can be used to create a playlist, and/or a human director 306 can create a playlist. One example of dynamic input from one or more users is a high school prom where dancers can add songs to and remove songs from the playlist on the fly. One example of a human director is a wedding planner who personally and manually orchestrates a playlist of music and video to suit the mood of the wedding and suit the bride and groom. One example of a prefabricated template is a store, such as The Gap, which selects a template of “Top 40 Hits” which is updated weekly to reflect the changing status of the top 40 songs in the country. Another example of a prefabricated template is “Christmas Music” or “Summer Music” for a homeowner hosting a social gathering. The homeowner wants any type of music fitting the description without the hassle of manually adding each and every possible song. However, a user can customize a prefabricated template 304 by adding or removing individual pieces of media.

The system combines the selected media into a playlist for the sequence 308. Commentary, demographic, and/or other information can be included in the playlist as well 310. As discussed above, the demographic or usage information can be used to allow individuals to vote in an election. In a scenario where media is protected, the media is checked for digital rights management (DRM) 312. Individual listeners may be required to pay to consume the media or the media may be wholly or partially prepaid by a third party. Next, the system queries the intended output devices to obtain profile descriptions 314. The system transcodes and adapts 316 the media content to match the output device profiles. For example, if the media is digital video at 1920×1080 resolution stored in Matroska format and the playback device is a PDA that cannot play Matroska format and is only capable of displaying a resolution of 320×480, the media can be transcoded and/or adapted for playback on the PDA. Transcoding can be done on the fly or in advance. The media is then output to other users or consumers 318. As other users consume the media content, the system reports usage statistics to multiple billing systems 320 such as Warner 320a, Rhapsody 320b, Sony 320c, Netflix 320d, or music associations such as BMI and ASCAP 320e. Users can authenticate via an account with these various billing systems individually or with a central interface through the system. A user account can store personal playlists as a service. In one aspect, the system makes recently consumed media available to the same user for free within a window of time. For example, a user who watches the music video for “November Rain” can rewatch the same clip as often as desired for up to one week.

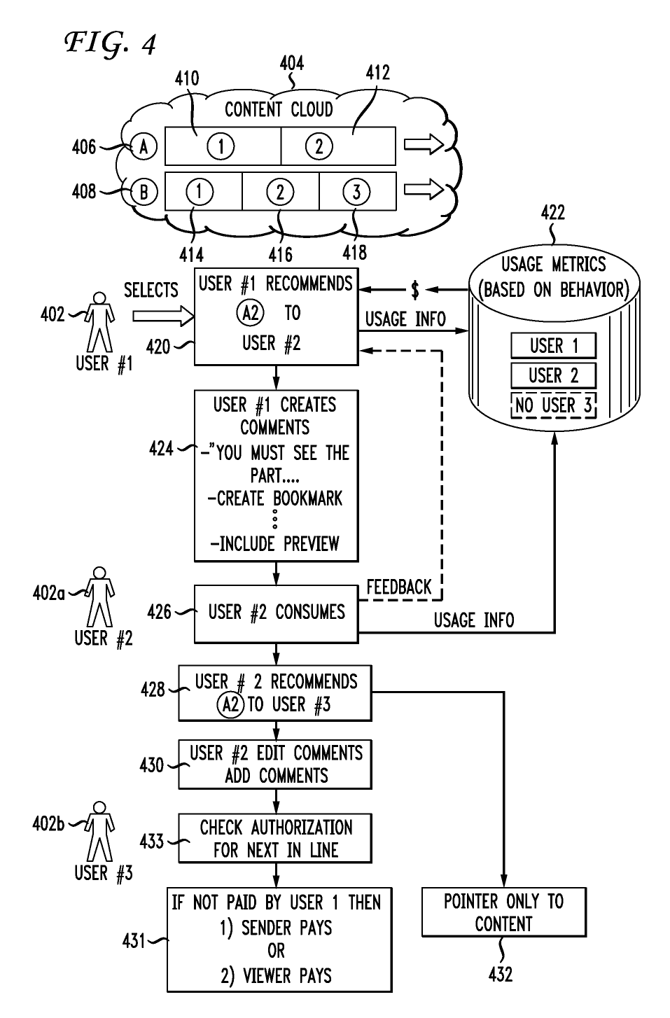

FIG. 4 illustrates how users interact with an example system. First, user #1 402 is friends with user #2 402a who is friends with user #3 402b. User #3 does not know user #1. The system makes media available in a content cloud 404 to user #1. The content cloud represents a library of media available locally or over a network. The depicted content cloud 404 contains media A 406 and media B 408. A is divided into two segments A1 410 and A2 412. B is divided into three segments, B1 414, B2 416, and B3 418. User #1 views the media content in the cloud and decides that user #2 might most enjoy segment A2. User #1 recommends A2 to user #2 420. The recommendation can be accomplished through the system, such as a recommendation request website that handles all the details, or it can be accomplished in an external way, such as sending a referral link via email or SMS independent of the system. When user #1 recommends the clip, usage information is sent to a usage metrics database 422. The usage metrics database stores an indicator that user #1 viewed the clip and referred it to user #2. User #1 creates comments 424 describing the video clip or explaining to user #2 the reasons to view the clip, such as “You must see the part where the guinea pig gets on the treadmill!” or “this might be relevant to your master's thesis”. Either user #1 or the system can generate a bookmark and/or a preview of the video clip. This can be provided as a service through a dedicated video hosting website such as YouTube or Hulu. It can be sent as an attachment in an email message. It can be sent to a video game console, mobile phone, PDA, digital video recorder, cable television set-top box, or any other device with a wired or wireless network connection.

User #2 receives the recommendation via email in this case and decides to consume 426, or view, clip A2. User #2 can provide feedback to user #1 based on the viewed clip. Such feedback can be provided in text, speech, still image, a video user #2 created, another referred video, or any other medium. Feedback may be as simple as a thumbs up/thumbs down, smiley face/frowny face, a number from 1 to 10, a star ranking (two stars, four stars, etc). Feedback can further include a notification that the recommended video clip was viewed and how many times it was viewed. The system reports usage information to the usage metrics database 422 indicating that user #2 has viewed the clip A2. Usage information can include the feedback sent to the referring party. If A2 is a clip that must be paid for, a part of the fee paid by user #2 is transferred to user #1 as a referral or recommendation fee. FIG. 5 is one example application of a referral fee payment scheme. In one variation, user #1 pays in advance for user #2, so the referral fee does not apply.

User #2 decides that his friend, user #3 402b, might like clip A2 and recommends A2 to user #3 428. User #2 can edit and/or add comments 430 which were created when user #1 recommended clip A2 to user #2. Often comments are specific to the relationship between a recommending party and the receiving party, so keeping them the same would make little sense in the context of downstream recommendations. For example, if user #1 is a mother and user #2 is a teenage child, the comments may contain additional information unrelated to the video clip, such as “and don't forget, I made you an appointment on Tuesday to see the dentist to get braces”, which could be embarrassing to the child if they were forwarded to a classmate. In other scenarios confidential, sensitive, or unrelated information are included in comments sent between business associates which should not be shared with others. Thus, the ability to redact, edit, or sanitize the comments of a clip is important when referring a clip to others.

If A2 is a clip that must be paid for and user #1 pays in advance for user #2 as a gift but does not pay for subsequent viewers, an authorization check 433 is performed for the next in line to determine how much, if anything, is charged to user #3 to view the clip. If it is not paid by user #1, then either the sender (user #2) pays or the viewer (user #3) pays 431. User #2 did not pay for it in advance, and user #3 chooses not to view the clip. No usage information is sent because user #3 opted not to view A2 412, so the usage metrics database 422 has no information regarding user #3 other than the fact that user #2 referred a video to user #3. In one aspect, a pointer, link, or reference to the content 432 is sent instead of the actual video clip to prevent unauthorized viewing. The system can use a security mechanism to ensure that viewed content is paid for in advance of playback. In one example, the pointer, link, or reference connects to a server which verifies payment and/or credentials before transmitting the clip.

FIG. 5 illustrates a referral tree. In this referral tree model, the content provider has established that the fee paid by an original consumer of a piece of media goes 100% to the content provider. The fee a referred consumer pays goes 68% to the content provider and the other 32% is divided among referring parties located between the consumer and the content provider. This model is exemplary. Other models exist, such as paying $0.05 to each referring party up to 5 levels deep or only paying the immediate referring party. Starting out, U1 requests playback of a video clip from the content provider. For this privilege, U1 pays $1.00 directly to the content provider. U1 refers the video to U2 and U3 who each pay $1.00 to the content provider. Of that $2.00, the content provider either reimburses or credits U1 $0.64 and the content provider retains $1.36.

U2 refers the video to U4, U5, and U6. U4 and U5 each pay $1.00 to view the video and U6 chooses not to view it. Of that $2.00, U2 gets $0.32, U1 gets $0.32, and the content provider gets $1.36.

U5 refers the video to U7 and U8. U7 chooses not to view it and U8 pays $1.00 to view the video. Of that $1.00, U5 gets $0.16, U2 gets $0.08, U1 gets $0.08, and the content provider gets $0.68.

U8 refers the video to U14 who pays $1.00 to view the video. Because U14 has two referrals, the issue of referral compensation for U8 is handled below.

U3 refers the video to U9. U9 pays $1.00 to view the video. Of that $1.00, U3 gets $0.16, U1 gets $0.16, and the content provider gets $0.68.

U9 refers the video to U10, U11, and U12. U10 and U12 each pay $1.00 to view the video and U11 chooses not to view it. Of that $2.00, U9 gets $0.32, U3 gets $0.16, U1 gets $0.16, and the content provider gets $1.36.

U10 refers the video to U13 who pays $1.00 to view the video. Of that $1.00, U10 gets $0.16, U9 gets $0.08, U3 gets $0.04, U1 gets $0.04, and the content provider gets $1.36.

U13 refers the video to U14 who pays $1.00 to view the video. The problem here is that both U8 and U13 referred the video to U14. This problem can be handled in many ways, but the way demonstrated here splits the referral fee evenly between co-equal referrers, in this case U7 and U13. Of the $1.00 paid by U14, U8 and U13 split the $0.32 equally and each receive $0.16, but that $0.16 is split with their upstream referring party, so U8 gets $0.08, U5 gets $0.04, U2 gets $0.02, and U1 gets $0.02. On the other side, U13 gets $0.08, U10 gets $0.04, U9 gets $0.02, U3 gets $0.01, and U1 gets an additional $0.01 for a total of $0.03. The content provider gets $0.68.

Under a scheme such as this, users can identify which of their friends is the most “profitable”, i.e. the most likely to refer the video to many people who pay to view it, and refer videos to those friends. If a user decides to pay in advance for a referral to view the video, the overall fee can be reduced to take into account that no referral fee is needed on that transaction. The exemplary fee of $1.00 per viewing can be replaced with a combination of any items or services of value such as viewing an advertisement. For example, viewing an advertisement or a number of advertisements can reduce or eliminate the fee. Advertisers may opt to pay or not pay referral fees on advertising-supported referred media.

Fees can range from very small to very large. Users can be charged microtransactions as little as pennies or fractions of pennies to offset the bandwidth and hosting costs associated with a very popular video clip. Users can be charged a premium of 25 dollars or more, for example, to view a real time or near real time clip of a boxing match, a horse race, or other sporting event. Video content can be a few seconds long or can be many hours. Many of the viral videos on YouTube are under 30 seconds. Educational or religious conferences can have running times of 2 or more hours. Any range of media durations and any range of costs are anticipated. In one aspect, the cost is proportional to the popularity and/or duration of the video clip. The principles described herein can be applied to online music stores, such as Apple's iTunes or RealNetworks' Rhapsody. Online music stores can charge fees and award referral fees based on popularity or exclusivity of a particular piece of media. One example of charging based on exclusivity is a non-profit organization that holds an online fundraiser by producing a special video relating to their cause which is only available for a limited number of viewings. Because the number of viewings is limited and exclusive and because the money paid goes to a good cause, the fee can be increased in a manner similar to political fundraiser dinners that are $1,000 a plate.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the processes described herein may have application in IP television, cable television services, and online education. Those skilled in the art will readily recognize various modifications and changes that may be made to the present invention without following the example embodiments and applications illustrated and described herein, and without departing from the true spirit and scope of the present invention.

We claim:

1. A method of recommending media content, the method comprising:
generating a playlist representing one or more media segments;
receiving comments describing the one or more media segments;
transmitting the playlist and received comments to one or more viewers; and
charging a fee for displaying one or more media segment.

2. The method of claim 1, wherein the fee charged is paid in full or in part by one or more of a recommending party, a third party, one or more viewer, and an advertiser in exchange for inserting advertising content in one or more of the playlist and the comments.

3. The method of claim 1, wherein a referral credit is granted recursively when the viewer recommends the playlist to a second viewer and a second fee is charged.

4. The method of claim 1, wherein received comments are generated based on one or more of media segment metadata, text or audio comments from a recommending party, and previously generated comments describing the media segment.

5. The method of claim 1, the method further comprising collecting statistics representing viewing habits of and personal information about the viewer.

6. The method of claim 5, the method further comprising holding an election based on collected statistics.

7. A system for recommending media content, the system comprising:
a module configured to generate a playlist representing one or more media segments;
a module configured to receive comments describing the one or more media segments;
a module configured to transmit the playlist and received comments to one or more viewers; and
a module configured to a fee for displaying one or more media segment.

8. The system of claim 7, wherein the fee charged is paid in full or in part by one or more of a recommending party, a third party, one or more viewer, and an advertiser in exchange for inserting advertising content in one or more of the playlist and the comments.

9. The system of claim 7, wherein a referral credit is granted recursively when the viewer recommends the playlist to a second viewer and a second fee is charged.

10. The system of claim 7, wherein received comments are generated based on one or more of media segment metadata, text or audio comments from a recommending party, and previously generated comments describing the media segment.

11. The system of claim 7, the system further comprising a module configured to collect statistics representing viewing habits of and personal information about the viewer.

12. The system of claim 11, the system further comprising a module configured to hold an election based on collected statistics.

13. A computer-readable medium storing a computer program having instructions for recommending media content, the instructions comprising:
generating a playlist representing one or more media segments;
receiving comments describing the one or more media segments;
transmitting the playlist and received comments to one or more viewers; and
charging a fee for displaying one or more media segment.

14. The computer-readable medium of claim 13, wherein the fee charged is paid in full or in part by one or more of a recommending party, a third party, one or more viewer, and an advertiser in exchange for inserting advertising content in one or more of the playlist and the comments.

15. The computer-readable medium of claim 13, wherein a referral credit is granted recursively when the viewer recommends the playlist to a second viewer and a second fee is charged.

16. The computer-readable medium of claim 13, wherein received comments are generated based on one or more of media segment metadata, text or audio comments from a recommending party, and previously generated comments describing the media segment.

17. The computer-readable medium of claim 13, the instructions further comprising collecting statistics representing viewing habits of and personal information about the viewer.

18. The computer-readable medium of claim 17, the instructions further comprising holding an election based on collected statistics.
